(19) United States
(12) Patent Application Publication
(10) Pub. No.: US 2025/0261149 A1
(43) Pub. Date: Aug. 14, 2025

(54) SERVICE AREA RESTRICTION ENFORCEMENT IN WIRELESS NETWORK

(71) Applicant: SAMSUNG ELECTRONICS CO., LTD., Suwon-si, Gyeonggi-do (KR)

(72) Inventors: Ashok Kumar NAYAK, Bangalore (IN); Varini GUPTA, Bangalore (IN); Sangjun MOON, Suwon-si (KR)

(21) Appl. No.: 18/862,116

(22) PCT Filed: May 4, 2023
(86) PCT No.: PCT/KR2023/006176

§ 371 Date: Oct. 31, 2024

(30) Foreign Application Priority Data
May 4, 2022 (IN) 202241025864
Apr. 3, 2023 (IN) 202241025864

(51) Int. Cl. H04W 60/00; H04W 48/16

(52) U.S. Cl. CPC H04W 60/00; H04W 48/16

(57) ABSTRACT

The disclosure relates to a 5th generation (5G) or 6th generation (6G) communication system for supporting a higher data transmission rate. According to an embodiment, a method performed by an access and mobility management function (AMF) entity in a mobile communication system is provided. The method comprises receiving, from a user equipment (UE), a registration request message, identifying at least one local area data network (LADN) service area per data network name (DNN) and single-network slice selection assistance information (S-NSSAI) based on information for identifying the at least one LADN service area and transmitting, to the UE, a registration accept message as a response to the registration request message, the registration accept message including DNN information and tracking area (TA) list information which correspond to the at least one LADN service area per DNN and S-NSSAI.

### TECHNICAL FIELD

The present disclosure relates generally to wireless communication systems and, more specifically, to service area restriction enforcement in wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

According to an embodiment, a method performed by an access and mobility management function (AMF) entity in a mobile communication system is provided. The method comprises receiving, from a user equipment (UE), a registration request message, identifying at least one local area data network (LADN) service area per data network name (DNN) and single-network slice selection assistance information (S-NSSAI) based on information for identifying the at least one LADN service area and transmitting, to the UE, a registration accept message as a response to the registration request message, the registration accept message including DNN information and tracking area (TA) list information which correspond to the at least one LADN service area per DNN and S-NSSAI.

According to an embodiment, an access and mobility management function (AMF) entity in a mobile communication system is provided. The AMF entity comprises a transceiver and a controller coupled with the transceiver and configured to receive, from a user equipment (UE), a registration request message, identify at least one local area data network (LADN) service area per data network name (DNN) and single-network slice selection assistance information (S-NSSAI) based on information for identifying the at least one LADN service area and transmit, to the UE, a registration accept message as a response to the registration request message, the registration accept message including DNN information and tracking area (TA) list information which correspond to the at least one LADN service area per DNN and S-NSSAI.

According to an embodiment, a method performed by a user equipment (UE) in a mobile communication system is provided. The method comprises transmitting, to an access and mobility management function (AMF) entity, a registration request message and receiving, from the AMF entity, the registration accept message as a response to the registration request message, the registration accept message including data network name (DNN) information and tracking area (TA) list information which correspond to at least one local area data network (LADN) service area per DNN and single-network slice selection assistance information (S-NSSAI). The at least one LADN service area is based on information associated with the at least one LADN service area.

According to an embodiment, a user equipment (UE) in a mobile communication system is provided. The UE comprises a transceiver and a controller coupled with the transceiver and configured to transmit, to an access and mobility management function (AMF) entity, a registration request message and receive, from the AMF entity, the registration accept message as a response to the registration request message, the registration accept message including data network name (DNN) information and tracking area (TA) list information which correspond to at least one local area data network (LADN) service area per DNN and single-network slice selection assistance information (S-NSSAI). The at least one LADN service area is based on information associated with the at least one LADN service area.

### BRIEF DESCRIPTION OF DRAWINGS

The proposed system and method are illustrated in the accompanying drawings, throughout which like reference letters indicate corresponding parts in the various figures. The embodiments herein will be better understood from the following description with reference to the drawings, in which:

FIG. 1 illustrates a flow chart for enforcing the service area restriction in a wireless network according to an embodiment;

FIG. 2 illustrates a flow chart for enforcing the service area restriction in the wireless network according to an embodiment;

FIG. 3 illustrates various example components of a UE according to an embodiment;

FIG. 4 illustrates various example components of an AMF apparatus according to an embodiment;

FIG. 5 illustrates various example components of an UDM apparatus according to an embodiment;

FIG. 6 illustrates various example components of a NEF apparatus according to an embodiment;

FIG. 7 is a flow chart illustrating a method, performed by the UE, for enforcing the service area restriction in the wireless network according to an embodiment;

FIG. 8 is a flow chart illustrating a method, performed by the AMF apparatus, for enforcing the service area restriction in the wireless network according to an embodiment;

FIG. 9 is a flow chart illustrating a method, performed by the UDM apparatus, for enforcing the service area restriction in the wireless network according to an embodiment;

FIG. 10 is a flow chart illustrating a method, performed by the NEF apparatus, for enforcing the service area restriction in the wireless network according to an embodiment;

FIG. 11 illustrates a structure of a UE according to an embodiment of the disclosure;

FIG. 12 illustrates a structure of a base station according to an embodiment of the disclosure; and

FIG. 13 is a block diagram showing an internal structure of a network entity, according to an embodiment of the disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for enforcing service area restriction in a wireless network. The method includes sending, by a UE in the wireless network, a registration request message to a AMF apparatus in the wireless network. Further, the method includes receiving, by the UE, service area information per at least one of DNN, S-NSSAI, and an access type from the AMF apparatus, where the service area information includes a list of TAs per DNN and S-NSSAI or only per DNN. Further, the method includes enforcing, by the UE, the service area restriction by initiating a PDU session for the received DNN and S-NSSAI, when the UE is present in a TA of the list of TAs received from the AMF apparatus.

The proposed method ensures that 5^{th} Generation (5G) network is able to provide mechanism to the AF apparatus for provisioning of service area restriction (e.g., Local Area Data Network (LADN) Service Area information or the like) and enforcing to the intended group of UEs.

The AF apparatus can provision a service area for a VN (virtual network) group or normal group. Then the network provides the service area per DNN/S-NSSAI and the UE need to enforce a policy. As part of the network enforcement, the AMF apparatus/the SMF apparatus reject when any service is requested outside the given service area.

For provisioning of service area, the existing VN group data is enhanced for provisioning of service area. The VN group is identified by combination of DNN and a S-NSSAI whereas other group need not to have the S-NSSAI. Hence when the AF/third party wants to provision service area for the VN group, the AF/third party has to provide the entire existing attribute along with service area. For the normal group, the AF/third party can provide only DNN and optionally S-NSSAI from the existing attribute and service area. The remaining existing attribute can be optional parameter for provisioning. The third party or AF apparatus can provision the service are per access type (AT) which means there can different service areas for 3GPP AT and N3GPP AT.

Below Table (1) shows the TS 23.502. Referring to the table 1, the proposed method illustrates the 5G VN group data enhanced to accommodate the service area.

TABLE 1
TS 23.502

| Parameters | Description |
|---|---|
| DNN | DNN for the 5G VN group |
| S-NSSAI | S-NSSAI for the 5G VN group |
| PDU Session Type | PDU Session Types allowed for 5G VN group |
| Application | There may be multiple instances of the |
| descriptor | information; the information may be used to |
| | build URSP sent to 5G VN group members |
| | (NOTE) |
| Information related | The information may indicate: |
| with secondary | the need for secondary |
| authentication/ | authentication/authorization (as |
| authorization | defined in clause 5.6 of TS 23.501); |
| | the need for SMF to request the UE IP |
| | address from the DN-AAA Server. |
| | If at least one of secondary |
| | authentication/authorization or DN-AAA |
| | UE IP address allocation is needed, the |
| | AF may provide DN-AAA Server |
| | addressing information. |
| Service area | Service area for the group (list of TAs) |

(NOTE)
As described in TS 23.503, the PCF may be configured with a mapping from Application Descriptor to other information required to construct the URSP rules, e.g. IP filters and SSC mode.

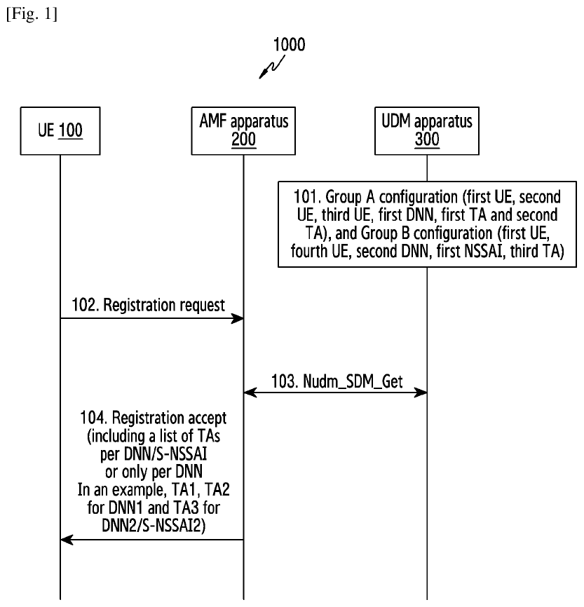

Referring now to the drawings and more particularly to FIG. 1 to FIG. 10, where similar reference characters denote corresponding features consistently throughout the figures, there are shown preferred embodiments.

When an operator or a third party service provider intends to provide some services to a specific group of User Equipment's (UEs) then, the operator or the third party service provider becomes difficult to provision all the attributes related to those services for each UEs. Hence creating a group and with all the intended UEs makes life easier for the operator or the third party service provider.

In release 18, the 3GPP has created one study item for group management. The release 18 specifies how fifth generation core (5GC) can provide mechanism to an Application Function (AF) for provisioning of service area restriction and Quality of Service (QoS) for the intended group of UEs. Below are the key issues (KIs) are considered. This key issue aims at addressing the following points:
1. How to provision (i.e. set, modify and delete) the service area or QoS applicable to each UE of the group via exposure interface, i.e.:
a. What is the information that constitutes the service area applicable to each UE of the group via an exposure interface, and how to enforce the service area applicable to each UE of the group by reusing the existing mechanisms,
b. What is the information that constitutes the QoS applicable to each UE of the group, and how to enforce the QoS applicable to each UE of the group using existing mechanisms.

Thus, it is desired to address the above mentioned disadvantages or other shortcomings or at least provide a useful alternative.

The principal object of the embodiments herein is to provide a system (or wireless network) and a method of enforcing that a 5G network is able to provide mechanism to an AF for provisioning of service area restriction and enforcing to the intended group of UEs. The AF apparatus can provision a service area for a Virtual Network (VN) group or a normal group. Then, the wireless network provides a service area per DNN/S-NSSAI and the UE need to enforce the policy. As part of the network enforcement, an AMF apparatus/a Session Management Function (SMF) apparatus reject when any service is requested outside the given service area.

Accordingly, the embodiment herein is to provide a method for enforcing service area restriction in a wireless network. The method includes sending, by a UE in the wireless network, a registration request message to a Access and Mobility Management Function (AMF) apparatus in the wireless network. Further, the method includes receiving, by the UE, service area information per at least one of Data Network Name (DNN), Single Network Slice Selection Assistance Information (S-NSSAI), and an access type from the AMF apparatus, where the service area information (e.g., Local Area Data Network (LADN) Service Area information or the like) includes a list of Tracking Areas (TAs) per DNN and S-NSSAI or only per DNN. Further, the method includes enforcing, by the UE, the service area restriction by initiating a PDU session for the received DNN and S-NSSAI, when the UE is present in a TA of the list of TAs received from the AMF apparatus.

In an embodiment, the method includes initiating, by the UE, the PDU session with the AMF apparatus for the received at least one of the DNN, the S-NSSAI, and the access type when the UE is not present in a TA of the list of TAs received from the AMF apparatus. Further, the method includes receiving, by the UE, a rejection message from the AMF apparatus.

In an embodiment, the method includes indicating, by the UE, support of receiving service area information per at least one of the DNN and the S-NSSAI in a UE MM Core Network Capability of the registration request message.

Accordingly, the embodiment herein is to provide a method for enforcing service area restriction in a wireless network. The method includes receiving, by an AMF apparatus in the wireless network, a registration request message from a UE in the wireless network. Further, the method includes determining, by the AMF apparatus, a service area information based on at least one of a local configuration and service area information received from an Unified Data Management (UDM) apparatus in the wireless network. Further, the method includes sending, by the AMF apparatus, the service area information per at least one of DNN, S-NSSAI, and an access type to the UE, wherein the service area information comprises a list of TAs per at least one of the DNN, the S-NSSAI, or the access type. Further, the method includes enforcing, by the AMF apparatus, the service area restriction for the UE in the wireless network based on the list of TAs per at least one of the DNN, the S-NSSAI, and the access type.

In an embodiment, the method includes receiving, by the AMF apparatus, a PDU session request message from the at least one UE for the DNN and the S-NSSAI. Further, the method includes determining, by the AMF apparatus, whether the UE is present in a TA of the list of TAs provided to the UE based on the PDU session request message. In an embodiment, the method includes accepting the PDU session request when the UE is present in a TA of the list of TAs provided to the UE. In another embodiment, the method includes rejecting, by the UE, the PDU session request when the UE is not present in a TA of the list of TAs provided to the UE.

In an embodiment, the service area information is received from the UDM apparatus by sending a request message to the UDM apparatus to retrieve subscriber data in the wireless network when the registration request message is received from the UE, and receiving the subscribed service area information along with the list of TAs per DNN and S-NSSAI from the UDM apparatus.

In an embodiment, the method includes detecting, by the AMF apparatus, a change in service area information for at least one of the DNN, the S-NSSAI, and access type for the UE. Further, the method includes sending, by the AMF apparatus, the updated service area information for at least one of the DNN, the S-NSSAI, and access type to the UE. Further, the method includes enforcing, by the AMF apparatus, the service area restriction for the UE in the wireless network based on the changes of the service area information to at least one of the DNN, the S-NSSAI, and access type.

Accordingly, the embodiment herein is to provide a method for enforcing service area restriction in a wireless network. The method includes receiving, by an UDM apparatus in the wireless network, a list of TAs along with at least one of DNN, S-NSSAI, and an access type corresponding to a service area provisioned for a UE in the wireless network from at least one of a Network Exposure Function (NEF) apparatus and an AF apparatus. Further, the method includes receiving, by the UDM apparatus, a Nudm_SDM_Get request message to retrieve subscriber data for the UE from an AMF apparatus in the wireless network. Further, the method includes sending, by the UDM apparatus, subscribed service area information along with the list of TAs per DNN and S-NSSAI for the UE to the AMF apparatus along with other subscriber data information.

In an embodiment, the UDM apparatus receives the list of TAs corresponding to the service area information provisioned for the group of UEs from the AF apparatus when the AF apparatus is a trusted AF.

In an embodiment, the UDM apparatus receives the list of TAs corresponding to the service area provisioned for the group of UEs from the NEF apparatus when the AF apparatus is an untrusted AF.

In an embodiment, the method includes detecting, by the UDM apparatus, a change in service area information for at least one of the DNN, the S-NSSAI, and the access type for the UE. Further, the method includes sending, by the UDM apparatus, the updated service area information for at least one of the DNN, the S-NSSAI, and the access type for the UE to the AMF apparatus.

Accordingly, the embodiment herein is to provide a method for enforcing service area restriction in a wireless network. The method includes receiving, by a NEF apparatus in the wireless network, geographical location identifier (ID) along with the DNN, the S-NSSAI and the access type provisioned for a UE in the wireless network from an AF apparatus. Further, the method includes converting, by the NEF apparatus, the geographical information to a list of TAs corresponding to a service area. Further, the method includes sending, by the NEF apparatus, the list of TAs corresponding to the service area to a UDM apparatus in the wireless network.

Accordingly, the embodiment herein is to provide a UE for enforcing service area restriction in a wireless network. The UE includes a service area restriction controller communicatively connected to a memory and a processor. The service area restriction controller sends a registration request message to an AMF apparatus in the wireless network. Further, the service area restriction controller receives service area information per at least one of DNN, S-NSSAI, and an access type from the AMF apparatus, where the service area information includes a list of TAs per DNN and S-NSSAI or only per DNN. Further, the service area restriction controller enforces the service area restriction by initiating a PDU session for the received DNN and S-NSSAI when the UE is present in a TA of the list of TAs received from the AMF apparatus.

Accordingly, the embodiment herein is to provide an AMF apparatus for enforcing service area restriction in a wireless network. The AMF apparatus includes a service area restriction controller communicatively connected to a memory and a processor. The service area restriction controller receives a registration request message from the UE in the wireless network. Further, the service area restriction controller determines a service area information based on at least one of a local configuration and service area information received from a UDM apparatus in the wireless network. Further, the service area restriction controller sends the service area information per at least one of DNN, S-NSSAI, and access type to the UE, where the service area information comprises a list of TAs per at least one of the DNN, the S-NSSAI, or the access type. Further, the service area restriction controller enforces the service area restriction for the UE in the wireless network based on the list of TAs per at least one of the DNN, the S-NSSAI, and the access type.

Accordingly, the embodiment herein is to provide a UDM apparatus for enforcing service area restriction in a wireless network. The UDM apparatus includes a service area restriction controller communicatively connected to a memory and a processor. The service area restriction controller receives a list of TAs along with at least one of DNN, S-NSSAI, and access type corresponding to a service area provisioned for a UE in the wireless network from at least one of a NEF apparatus and an AF apparatus. Further, the service area restriction controller receives a Nudm_SDM_Get request message to retrieve subscriber data for the UE from an AMF apparatus in the wireless network. Further, the service area restriction controller sends subscribed service area information along with the list of TAs per DNN and S-NSSAI for the UE to the AMF apparatus.

Accordingly, the embodiment herein is to provide a NEF apparatus for enforcing service area restriction in a wireless network. The NEF apparatus includes a service area restriction controller communicatively connected to a memory and a processor. The service area restriction controller receives geographical location identifier (id) along with DNN, the access type, and S-NSSAI provisioned for the group of UEs in the wireless network from an AF apparatus. Further, the service area restriction controller converts the geographical information to a list of TAs corresponding to the service area. Further, the service area restriction controller sends the list of TAs corresponding to the service area to a UDM apparatus in the wireless network.

These and other aspects of the embodiments herein will be better appreciated and understood when considered in conjunction with the following description and the accompanying drawings. It should be understood that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

FIG. 1 illustrates a flow chart for illustrating of enforcing the service area restriction in a wireless network (100) according to an embodiment.

According to an embodiment, an AMF apparatus (200) may receive a service area (e.g., list of TAs or the like) details from an UDM (unified data management) apparatus (300) during registration of a group UEs (100).

According to an embodiment, the UDM apparatus (300) sends (or, transmit) the list of TAs to the UE (100) per DNN and/or S-NSSAI where S-NSSAI can be optional. For a VN (virtual network) group, the S-NSSAI may be present or may be provided whereas for a normal group, the S-NSSAI may not be present or may not be provided.

In case that the AMF apparatus (200) may receive service area (list of TAs) per AT then accordingly the AMF apparatus (200) provides when same UE does registration for the 3GPP AT and N3GPP AT. In case that the UE (100) receive list of TAs per DNN then the UE (100) shall not initiate any NAS request for the DNN when the UE (100) goes outside of TA. When the UE (100) receives the list of TAs per DNN/S-NSSAI then the UE (100) shall not initiate any NAS request for the DNN/S-NSSAI when the UE (100) goes outside of TA. In the above case, the UE (100) may trigger NAS request for the same DNN with a different S-NSSAI combination or same S-NSSAI with a different DNN combination. The steps are as follows:

According to an embodiment, in step 101, two groups has been created (or, identified). For example, Group A is normal group as only DNN information is present or provided. Group B is a VN group as DNN and S-NSSAI is present.

For clarity other parameters of VN group is not shown. In an example, the group A configuration includes the first UE, the second UE, the third UE, the first DNN, the first TA and the second TA, and the group B configuration includes the first UE, the fourth UE, the second DNN, the first NSSAI, and the third TA.

According to an embodiment, in step 102, the UE (100) may transmit (or, send) the registration request to the AMF apparatus (200).

According to an embodiment, in step 103, the AMF apparatus (200) may receive group data (or, group configuration information) from the UDM apparatus (300) by Nudm_SDM_Get message. As the first UE is part of both the groups, both information is received by the AMF apparatus (200).

According to an embodiment, in step 104, The AMF apparatus (200) may provide the list of TAs part of service area. As the first UE is part of group A and group B, the first UE may receive group configuration information. For example, the first UE may receive TA1, TA2 for DNN1 and TA3 for DNN2/S-NSSAI2 included the group configuration information.

According to an embodiment, the UE (100) may receive the group configuration information including at least one of TA1, TA2-DNN1, TA3, or DNN2/S-NSSAI2. The first UE won't trigger any NAS in case that the first UE is outside of TA1 and/or TA2 while initiating PDU using DNN1. The first UE won't trigger any NAS in case that the first UE is outside of TA3 while initiating PDU using DNN2/S-NSSAI2. But, the first UE can very much trigger for either DNN2 with some other slice combination like S-NSSAI3 or S-NSSAI2 with other DNN combination like DNN3.

According to an embodiment, the third party/the AF (application function) apparatus may provision or provide service area for a group using existing 5G VN group data by providing only DNN and optionally S-NSSAI which then is treated as normal group. As another example, the third party/AF apparatus may provision or provide service area for the 5G VN group just by adding service area along with all the existing parameters.

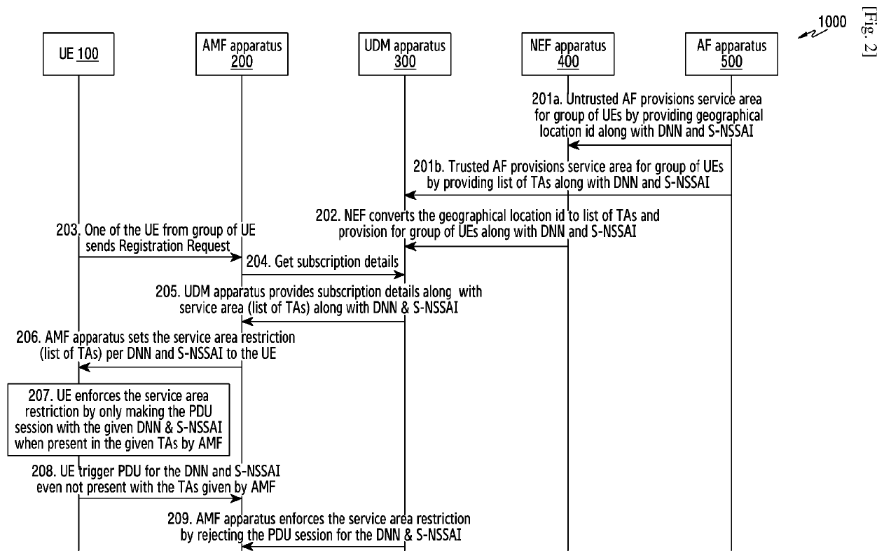

According to an embodiment, in case that the AF apparatus is not trusted then the provisioning is done through the NEF apparatus (400) and the NEF apparatus (400) converts service area (e.g., geographical area provided by the AF apparatus (500)) to list of TAs but in case that the AF apparatus (500) is trusted then, the AF apparatus (500) need to provision directly the list of TAs instead of the geographical area (as shown in FIG. 2).

In an embodiment, the AF apparatus (500) may provision different service area per AT. One service area per 3GPP AT whereas different service area for N3GPP AT. In this case, the UDM apparatus (300) shall only provide the list of TAs based on the AT, the AMF apparatus (200) is mentioning while getting subscription from it.

In an embodiment, the AMF apparatus (200) enforces the service area restriction by providing the list of TAs per DNN/S-NSSAI or only per DNN received from the UDM apparatus (300) during registration of UEs of a particular group. When the service area per AT is not received from the UDM apparatus (300) (i.e., service area is not configured per AT by the AF apparatus (500)) then the AMF apparatus (200) provides same list of TAs when the UE (100) does registrations for both 3GPP and N3GPP AT.

In an embodiment, the UE (100) shall not initiate any NAS request for the DNN/S-NSSAI combination when the list of TAs is received per DNN/S-NSSAI when the first UE is outside of it. The first UE can trigger NAS request for the same DNN with a different S-NSSAI combination or same S-NSSAI with a different DNN combination.

In an embodiment, the UE (100) shall not initiate any NAS request for the DNN when the list of TAs is received per DNN when the UE (100) is outside of TA.

In an embodiment, the UE (100) shall store the list of TAs of service area per DNN/S-NSSAI or per DNN and per AT.

FIG. 2 illustrates a flow chart for illustrating of enforcing the service area restriction in the wireless network (1000) according to an embodiment.

According to an embodiment, at step 201a, the AF apparatus (500) may provide the untrusted AF provisions service area for group of UEs by providing geographical location ID along with the DNN and the S-NSSAI to the NEF apparatus (400). Alternatively, at step 201b, the AF apparatus (500) may provide the trusted AF provisions service area for the group of UEs by providing list of TAs along with DNN and S-NSSAI to the UDM apparatus (300).

According to an embodiment, at step 202, the NEF apparatus (400) may convert the geographical location ID to list of TAs and provision for group of UEs along with the DNN and the S-NSSAI to the UDM apparatus (300).

According to an embodiment, at step 203, one of the UE (100) from the group of UEs may transmit (or, send) the registration request to the AMF apparatus (200). At step 204, the AMF apparatus (200) may obtain the subscription details from the UDM apparatus (300). At step 205, the UDM apparatus provides subscription details along with the service area (e.g., list of TAs) along with the DNN & S-NSSAI to the AMF apparatus (200).

According to an embodiment, at step 206, the AMF apparatus (200) may set or configure the service area restriction (e.g., list of TAs) per DNN and S-NSSAI to the UE (100). At step 207, the UE (100) may enforce the service area restriction by only making the PDU session with the given DNN & S-NSSAI when present in the given TAs by the AMF apparatus (200). At step 208, the UE (100) may trigger the PDU for the DNN and S-NSSAI even not present with the TAs given by the AMF apparatus (200). At step 209, the AMF apparatus (200) may enforce the service area restriction by rejecting the PDU session for the DNN & S-NSSAI.

The operations of the UE (100), the AMF apparatus (200), the UDM apparatus (300) and/or the NEF apparatus (400) are illustrated in FIG. 2 to FIG. 6, respectively.

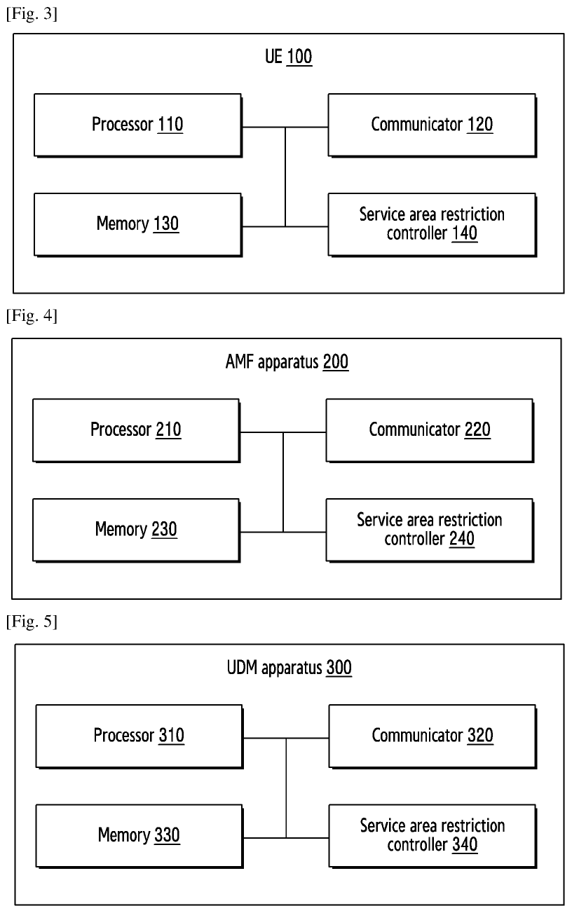

FIG. 3 illustrates example hardware components of the UE (100) according to an embodiment.

According to an embodiment, the UE (100) may include a processor (110) (or, controller), a communicator (120), a memory (130) and/or a service area restriction controller (140). The processor (110) may be coupled with the communicator (120), the memory (130) and/or the service area restriction controller (140).

Even though it is illustrated that the UE (100) may include the processor (110) and the service area restriction controller (140) in FIG. 3, the UE may include a controller (or, at least one processor) that replace the processor (110) and the service area restriction controller (140).

The service area restriction controller (140) sends the registration request message to the AMF apparatus (200). Further, the service area restriction controller (140) receives the service area information per at least one of the DNN, the S-NSSAI, and the access type from the AMF apparatus (200). The service area information includes the list of TAs per DNN and S-NSSAI or only per DNN. Further, the service area restriction controller (140) enforces the service area restriction by initiating the PDU session for the received DNN and S-NSSAI when the UE (100) is present in the TA of the list of TAs received from the AMF apparatus (200).

Further, the service area restriction controller (140) initiates the PDU session with the AMF apparatus (200) for the received at least one of the DNN, the S-NSSAI, and the access type when the UE (100) is not present in the TA of the list of TAs received from the AMF apparatus (200). Further, the service area restriction controller (140) receives the rejection message from the AMF apparatus (200). Further, the service area restriction controller (140) indicates support of receiving service area information per the DNN, the S-NSSAI and the access type in a UE MM Core Network Capability of the registration request message.

The service area restriction controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. The term “non-transitory” should not be interpreted that the memory (130) is non-movable. In certain examples, a non-transitory storage medium may store data that can, over time, change (e.g., in Random Access Memory (RAM) or cache).

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 4 illustrates example hardware components of the AMF apparatus (200) according to an embodiment.

According to an embodiment, the AMF apparatus (200) may include a processor (210), a communicator (220), a memory (230) and/or a service area restriction controller (240). The processor (210) may be coupled with the communicator (220), the memory (230) and the service area restriction controller (240).

The service area restriction controller (240) receives the registration request message from the UE (100) and determines the service area information based on at least one of the local configuration and the service area information received from the UDM apparatus (300). In an embodiment, the service area information is received from the UDM apparatus (300) by sending a request message to the UDM apparatus (300) to retrieve subscriber data in the wireless network (1000) when the registration request message is received from the UE (100), and receiving the subscribed service area information along with the list of TAs per DNN and S-NSSAI from the UDM apparatus (300). Further, the service area restriction controller (240) sends the service area information per at least one of the DNN, the S-NSSAI, and the access type to the UE (100), where the service area information includes a list of TAs per at least one of the DNN, the S-NSSAI, or the access type. Further, the service area restriction controller (240) enforces the service area restriction for the UE (100) based on the list of TAs per at least one of the DNN, the S-NSSAI, and the access type.

Further, the service area restriction controller (240) receives the PDU session request message from the UE (100) for the DNN and the S-NSSAI. Further, the service area restriction controller (240) determines whether the UE (100) is present in the TA of the list of TAs provided to the UE (100) based on the PDU session request message. In an embodiment, the service area restriction controller (240) accepts the PDU session request when the UE (100) is present in the TA of the list of TAs provided to the UE (100). In an embodiment, the service area restriction controller (240) rejects the PDU session request when the UE (100) is not present in the TA of the list of TAs provided to the UE (100).

Further, the service area restriction controller (240) detects a change in service area information for at least one of the DNN, the S-NSSAI, and access type for the UE (100). Further, the service area restriction controller (240) sends the updated service area information for at least one of the DNN, the S-NSSAI, and access type to the UE (100). Based on the changes to the service area information for at least one of the DNN, the S-NSSAI, and t access type, the service area restriction controller (240) enforces the service area restriction for the UE (100).

The service area restriction controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. The term “non-transitory” should not be interpreted that the memory (230) is non-movable. In certain examples, a non-transitory storage medium may store data that can, over time, change (e.g., in Random Access Memory (RAM) or cache).

Although the FIG. 4 shows various hardware components of the AMF apparatus (200) but it is to be understood that other embodiments are not limited thereon. In other embodiments, the AMF apparatus (200) may include less or more number of components. Further, the labels or names of the components are used only for illustrative purpose and does not limit the scope of the invention. One or more components can be combined together to perform same or substantially similar function in the AMF apparatus (200).

FIG. 5 illustrates example hardware components of the UDM apparatus (300) according to an embodiment.

According to an embodiment, the UDM apparatus (300) may include a processor (310), a communicator (320), a memory (330) and/or a service area restriction controller (340). The processor (310) may be coupled with the communicator (320), the memory (330) and/or the service area restriction controller (340).

The service area restriction controller (340) receives the list of TAs along with at least one of the DNN, the S-NSSAI, and the access type corresponding to the service area provisioned for the UE (100) from at least one of the NEF apparatus (400) and the AF apparatus (500). The service area restriction controller (340) receives the list of TAs corresponding to the service area information provisioned for the group of UEs (100) from the AF apparatus (500) when the AF apparatus (500) is a trusted AF apparatus. The service area restriction controller (340) receives the list of TAs corresponding to the service area provisioned for the group of UEs (100) from the NEF apparatus (400) when the AF apparatus (500) is an untrusted AF apparatus. Further, the service area restriction controller (340) receives a Nudm_SDM_Get request message to retrieve subscriber data for the UE (100) from an AMF apparatus (200). Further, the service area restriction controller (340) sends the subscribed service area information along with the list of TAs per DNN and S-NSSAI for the UE (100) to the AMF apparatus (200).

Further, the service area restriction controller (340) detects a change in the service area information for the DNN, the S-NSSAI, and the access type for the UE (100). Further, the service area restriction controller (340) sends the changes in at least one of the service area information for the DNN, the S-NSSAI, and the access type for the UE (100) to the AMF apparatus (200).

The service area restriction controller (340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. The term “non-transitory” should not be interpreted that the memory (330) is non-movable. In certain examples, a non-transitory storage medium may store data that can, over time, change (e.g., in Random Access Memory (RAM) or cache).

Although the FIG. 5 shows various hardware components of the UDM apparatus (300) but it is to be understood that other embodiments are not limited thereon. In other embodiments, the UDM apparatus (300) may include less or more number of components. Further, the labels or names of the components are used only for illustrative purpose and does not limit the scope of the invention. One or more components can be combined together to perform same or substantially similar function in the UDM apparatus (300).

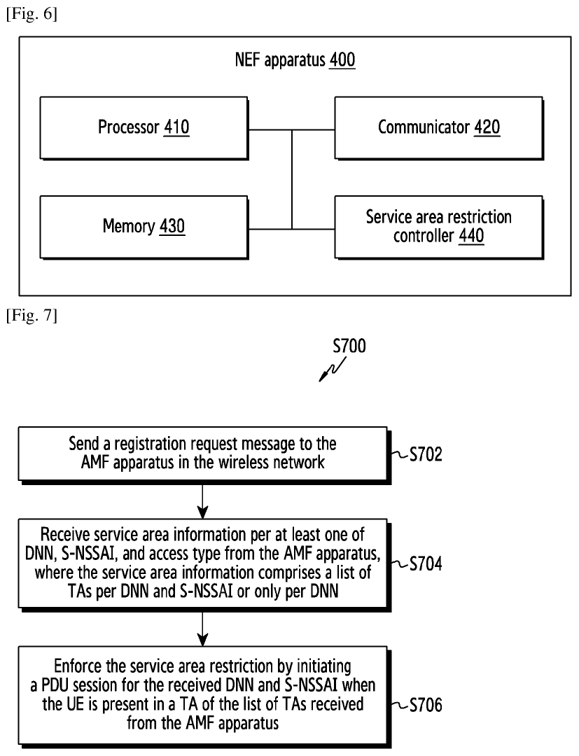

FIG. 6 shows various hardware components of the NEF apparatus (400), according to the embodiments as disclosed herein. In an embodiment, the NEF apparatus (400) includes a processor (410), a communicator (420), a memory (430) and a service area restriction controller (440). The processor (410) is coupled with the communicator (420), the memory (430) and the service area restriction controller (440).

The service area restriction controller (440) receives geographical location identifier (id) along with the DNN, the access type, and the S-NSSAI provisioned for the group of UEs (100) from an AF apparatus (500). Further, the service area restriction controller (440) converts the geographical information to a list of TAs corresponding to the service area and sends the list of TAs corresponding to the service area to the UDM apparatus (300).

The service area restriction controller (440) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (430) may, in some examples, be considered a non-transitory storage medium. The term “non-transitory” may indicate that the storage medium is not embodied in a carrier wave or a propagated signal. The term “non-transitory” should not be interpreted that the memory (430) is non-movable. In certain examples, a non-transitory storage medium may store data that can, over time, change (e.g., in Random Access Memory (RAM) or cache).

Although the FIG. 6 shows various hardware components of the NEF apparatus (400) but it is to be understood that other embodiments are not limited thereon. In other embodiments, the NEF apparatus (400) may include less or more number of components. Further, the labels or names of the components are used only for illustrative purpose and does not limit the scope of the invention. One or more components can be combined together to perform same or substantially similar function in the NEF apparatus (400).

FIG. 7 is a flow chart (S700) illustrating a method, performed by the UE (100), for enforcing the service area restriction in the wireless network (1000) (or, wireless communication network) according to an embodiment. The operations (S702-S706) are handled by the service area restriction controller (140).

At S702, the UE (100) may send (or, transmit) the registration request message to the AMF apparatus (200) in the wireless network (1000). At S704, the UE (100) may receive the service area information per at least one of DNN, the S-NSSAI, or the access type from the AMF apparatus (200). For example, the service area information may include the list of TAs per DNN and S-NSSAI or only per DNN. At S706, the UE may enforce the service area restriction by initiating the PDU session for the received DNN and S-NSSAI in case that the UE (100) is present or included in the TA of the list of TAs received from the AMF apparatus (200).

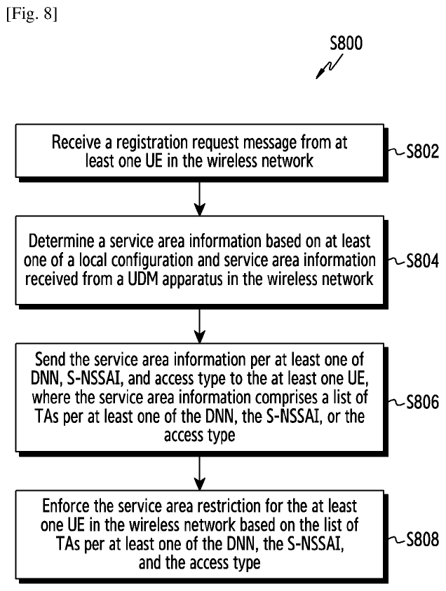

FIG. 8 is a flow chart (S800) illustrating a method, performed by the AMF apparatus (200), for enforcing the service area restriction in the wireless network (1000) according to an embodiment. The operations (S802-S808) are handled by the service area restriction controller (240) or the processor (210). As another example, the operations are processed by the controller included in the AMF apparatus (200).

According to an embodiment, at S802, the AMF apparatus (200) may receive the registration request message from the UE (100) in the wireless network (1000). At S804, the AMF apparatus (200) may determine (or, identify) the service area information based on at least one of the local configuration or service area information received from the UDM apparatus (300) in the wireless network (1000).

According to an embodiment, at S806, the AMF apparatus (200) may send (or, transmit) the service area information per at least one of DNN, S-NSSAI, or access type to the UE (100). The service area information may include a list of TAs per at least one of the DNN, the S-NSSAI, or the access type. At S808, the AMF apparatus (200) may enforce the service area restriction for the UE (100) in the wireless network (1000) based on the list of TAs per at least one of the DNN, the S-NSSAI, or the access type. For example, the AMF apparatus (200) may restrict the service area for the UE (100) in the wireless communication network based on the list of Tas per at least one of the DNN, the S-NSSAI, or the access type.

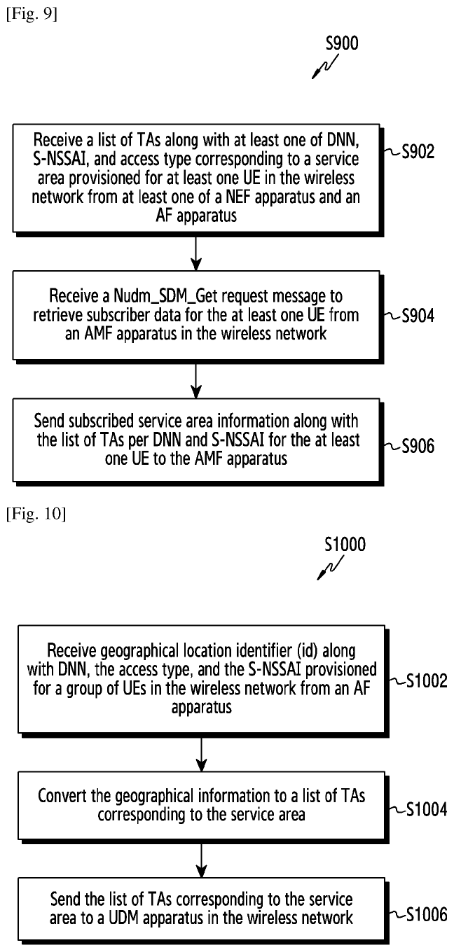

FIG. 9 is a flow chart (S900) illustrating a method, performed by the UDM apparatus (300), for enforcing the service area restriction in the wireless network (1000) according to an embodiment. The operations (S902-S906) are handled by the service area restriction controller (340) or the processor 310.

According to an embodiment, at S902, the UDM apparatus (300) may receive the list of TAs along with at least one of DNN, S-NSSAI, and access type corresponding to the service area provisioned for the UE (100) in the wireless network (1000) from at least one of the NEF apparatus (400) and the AF apparatus (500).

At S904, the UDM apparatus (300) mat receive the Nudm_SDM_Get request message to retrieve subscriber data for the UE (100) from the AMF apparatus (200) in the wireless network (1000). At S906, the UDM apparatus (300) may send (or, transmit) the subscribed service area information along with the list of TAs per DNN and S-NSSAI for the UE (100) to the AMF apparatus (200).

FIG. 10 is a flow chart (S1000) illustrating a method, performed by the NEF apparatus (400), for enforcing the service area restriction in the wireless network (1000), according to the embodiments as disclosed herein. The operations (S1002-S1006) are handled by the service area restriction controller (440) or the processor (410).

According to an embodiment, at S1002, the NEF apparatus (400) may receive the geographical location identifier (id) along with the DNN, access type, and the S-NSSAI provisioned for the group of UEs (100) in the wireless network (1000) from the AF apparatus (500). At S1004, the NEF apparatus (400) may convert the geographical information to a list of TAs corresponding to the service area. At S1006, the NEF apparatus (400) may send (or, transmit) the list of TAs corresponding to the service area to the UDM apparatus (300) in the wireless network (1000).

The various actions, acts, blocks, steps, or the like in the flow charts (S700-S1000) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

According to an embodiment, a method performed by an access and mobility management function (AMF) entity in a mobile communication system is provided. The method comprises receiving, from a user equipment (UE), a registration request message, identifying at least one local area data network (LADN) service area per data network name (DNN) and single-network slice selection assistance information (S-NSSAI) based on information for identifying the at least one LADN service area and transmitting, to the UE, a registration accept message as a response to the registration request message, the registration accept message including DNN information and tracking area (TA) list information which correspond to the at least one LADN service area per DNN and S-NSSAI.

The information is obtained from a local configuration or is received from a unified data management (UDM) entity.

The TA list information is mapped with geographical information.

The method further comprises receiving, from the UE, a protocol data unit (PDU) session request message in case that the UE is in the at least one LADN service area and transmitting, to the UE, accept message as a response to the PDU session request message.

According to an embodiment, an access and mobility management function (AMF) entity in a mobile communication system is provided. The AMF entity comprises a transceiver and a controller coupled with the transceiver and configured to receive, from a user equipment (UE), a registration request message, identify at least one local area data network (LADN) service area per data network name (DNN) and single-network slice selection assistance information (S-NSSAI) based on information for identifying the at least one LADN service area and transmit, to the UE, a registration accept message as a response to the registration request message, the registration accept message including DNN information and tracking area (TA) list information which correspond to the at least one LADN service area per DNN and S-NSSAI.

The information is obtained from a local configuration or is received from a unified data management (UDM) entity.

The TA list information is mapped with geographical information.

The controller is further configured to receive, from the UE, a protocol data unit (PDU) session request message in case that the UE is in the at least one LADN service area and transmit, to the UE, accept message as a response to the PDU session request message.

A method performed by a user equipment (UE) in a mobile communication system is provided. The method comprises transmitting, to an access and mobility management function (AMF) entity, a registration request message and receiving, from the AMF entity, the registration accept message as a response to the registration request message, the registration accept message including data network name (DNN) information and tracking area (TA) list information which correspond to at least one local area data network (LADN) service area per DNN and single-network slice selection assistance information (S-NSSAI). The at least one LADN service area is based on information associated with the at least one LADN service area.

The information associated with the at least one LADN service area is associated with a local configuration or at least one subscribed LADN service area of a unified data management (UDM) entity.

The TA list information is mapped with geographical information.

The method further comprises transmitting, to the AMF entity, a protocol data unit (PDU) session request message in case that the UE is in the at least one LADN service area and receiving, from the AMF entity, accept message as a response to the PDU session request message.

A user equipment (UE) in a mobile communication system is provided. The UE comprises a transceiver and a controller coupled with the transceiver and configured to transmit, to an access and mobility management function (AMF) entity, a registration request message and receive, from the AMF entity, the registration accept message as a response to the registration request message, the registration accept message including data network name (DNN) information and tracking area (TA) list information which correspond to at least one local area data network (LADN) service area per DNN and single-network slice selection assistance information (S-NSSAI). The at least one LADN service area is based on information associated with the at least one LADN service area.

The TA list information is mapped with geographical information.

The controller is further configured to transmit, to the AMF entity, a protocol data unit (PDU) session request message in case that the UE is in the at least one LADN service area and receive, from the AMF entity, accept message as a response to the PDU session request message.

Embodiments herein provide a method for enforcing service area restriction in a wireless network (1000) by a UE (100). The method includes sending a registration request message to an AMF apparatus (200) in the wireless network (1000). Further, the method includes receiving service area information per at least one of Data Network Name (DNN), Single Network Slice Selection Assistance Information (S-NSSAI), and an access type from the AMF apparatus (200), where the service area information includes a list of TAs per DNN and S-NSSAI or only per DNN. Further, the method includes enforcing the service area restriction by initiating a PDU session for the received DNN and S-NSSAI, when the UE (100) is present in a TA of the list of TAs received from the AMF apparatus (200).

A method for enforcing service area restriction in a wireless network (1000) is provided. wherein the method comprises sending, by a user equipment (UE) (100) in the wireless network (1000), a registration request message to a Access and Mobility Management Function (AMF) apparatus (200) in the wireless network (1000), receiving, by the UE (100), service area information per at least one of Data Network Name (DNN), Single Network Slice Selection Assistance Information (S-NSSAI), and an access type from the AMF apparatus (200), wherein the service area information comprises a list of Tracking Areas (TAs) per DNN and S-NSSAI or only per DNN and enforcing, by the UE (100), the service area restriction by initiating a PDU session for the received DNN and S-NSSAI, when the UE (100) is present in a TA of the list of TAs received from the AMF apparatus (200).

The method comprises initiating, by the UE (100), the PDU session with the AMF apparatus (200) for the received at least one of the DNN, the S-NSSAI, and the access type when the UE (100) is not present in a TA of the list of TAs received from the AMF apparatus (200) and receiving, by the UE (100), a rejection message from the AMF apparatus (200).

The method comprises indicating, by the UE (100), support of receiving service area information per at least one of the DNN and the S-NSSAI in a UE MM Core Network Capability of the registration request message.

A method for enforcing service area restriction in a wireless network (1000) is provided. The method comprises receiving, by an AMF apparatus (200) in the wireless network (1000), a registration request message from at least one UE (100) in the wireless network (1000), determining, by the AMF apparatus (200), a service area information based on at least one of a local configuration and the service area information received from an UDM apparatus (300) in the wireless network (1000), sending, by the AMF apparatus (200), the service area information per at least one a DNN, a S-NSSAI, and an access type to the at least one UE (100), wherein the service area information comprises a list of TAs per at least one of the DNN, the S-NSSAI, or the access type and enforcing, by the AMF apparatus (200), the service area restriction for the at least one UE (100) in the wireless network (1000) based on the list of TAs per at least one of the DNN, the S-NSSAI, and the access type.

The method comprises receiving, by the AMF apparatus (200), a PDU session request message from the at least one UE (100) for the DNN and the S-NSSAI, determining, by the AMF apparatus (200), whether the UE (100) is present in a TA of the list of TAs provided to the at least one UE (100) based on the PDU session request message and performing, by the AMF apparatus (200), one of accepting the PDU session request when the UE (100) is present in at least one TA of the list of TAs provided to the UE (100), and rejecting, by the UE (100), the PDU session request when the UE (100) is not present in the at least one TA of the list of TAs provided to the UE (100).

The service area information is received from the UDM apparatus (300) by sending a request message to the UDM apparatus (300) to retrieve subscriber data in the wireless network (1000) when the registration request message is received from the at least one UE (100) and receiving the subscribed service area information along with the list of TAs per DNN and S-NSSAI from the UDM apparatus (300).

The method comprises detecting, by the AMF apparatus (200), a change in the service area information for at least one of the DNN, the S-NSSAI, and the access type for the at least one UE (100), sending, by the AMF apparatus (200), the service area information for at least one of the DNN, the S-NSSAI, and the access type to the at least one UE (100) and enforcing, by the AMF apparatus (200), the service area restriction for the at least one UE (100) in the wireless network (1000) based on the changes to service area information for at least one of the DNN, the S-NSSAI, and the access type.

A method for enforcing service area restriction in a wireless network (1000) is provided. The method comprises receiving, by an UDM apparatus (300) in the wireless network (1000), a list of TAs along with at least one of DNN, S-NSSAI, and an access type corresponding to a service area provisioned for at least one UE (100) in the wireless network (1000) from at least one of a NEF apparatus (400) and an AF apparatus (500), receiving, by the UDM apparatus (300), a Nudm_SDM_Get request message to retrieve subscriber data for the at least one UE (100) from an AMF apparatus (200) in the wireless network (1000) and sending, by the UDM apparatus (300), subscribed service area information along with the list of TAs per DNN and S-NSSAI for the at least one UE (100) to the AMF apparatus (200).

The UDM apparatus (300) receives the list of TAs corresponding to the service area information provisioned for the at least one UE (100) from the AF apparatus (500) when the AF apparatus (500) is a trusted AF apparatus.

The UDM apparatus (300) receives the list of TAs corresponding to the service area provisioned for the at least one UE (100) from the NEF apparatus (400) when the AF apparatus (500) is an untrusted AF apparatus.

The method comprises detecting, by the UDM apparatus (300), a change in the service area information for at least one of the DNN, the S-NSSAI, and the access type for the at least one UE (100) and sending, by the UDM apparatus (300), the updated service area information for at least one of the DNN, the S-NSSAI, and the access type for the at least one UE (100) to the AMF apparatus (200).

A method for enforcing service area restriction in a wireless network (1000) is provided. The method comprises receiving, by a NEF apparatus (400) in the wireless network (1000), geographical location identifier (ID) along with DNN, an access type, and S-NSSAI provisioned for at least one UE (100) in the wireless network (1000) from an AF apparatus (500), converting, by the NEF apparatus (400), geographical information to a list of TAs corresponding to a service area and sending, by the NEF apparatus (400), the list of TAs corresponding to the service area to a UDM apparatus (300) in the wireless network (1000).

A UE (100) for enforcing service area restriction in a wireless network (1000) is provided. The UE (100) comprises a memory (130), a processor (110) and a service area restriction controller (140), communicatively connected to the memory (130) and the processor (110), configured to send a registration request message to a Access and Mobility Management Function (AMF) apparatus (200) in the wireless network (1000), receive service area information per at least one of Data Network Name (DNN), Single Network Slice Selection Assistance Information (S-NSSAI), and access type from the AMF apparatus (200), wherein the service area information comprises a list of Tracking Areas (TAs) per DNN and S-NSSAI or only per DNN and enforce the service area restriction by initiating a PDU session for the received DNN and S-NSSAI when the UE (100) is present in a TA of the list of TAs received from the AMF apparatus (200).

The service area restriction controller (140) is configured to initiate the PDU session with the AMF apparatus (200) for the received at least one of the DNN, the S-NSSAI, and the access type when the UE (100) is not present in a TA of the list of TAs received from the AMF apparatus (200) and receive a rejection message from the AMF apparatus (200).

The service area restriction controller (140) is configured to indicate support of receiving service area information per at least one of the DNN and the S-NSSAI in a UE MM Core Network Capability of the registration request message.

An AMF apparatus (200) for enforcing service area restriction in a wireless network (1000) is provided. The AMF apparatus (200) comprises a memory (230), a processor (210) and a service area restriction controller (240), communicatively connected to the memory (230) and the processor (210), configured to receive a registration request message from at least one UE (100) in the wireless network (1000), determine a service area information based on at least one of a local configuration and service area information received from a UDM apparatus (300) in the wireless network (1000), send the service area information per at least one of a DNN, a S-NSSAI, and an access type to the at least one UE (100), wherein the service area information comprises a list of TAs per at least one of the DNN, the S-NSSAI, or the access type and enforce the service area restriction for the at least one UE (100) in the wireless network (1000) based on the list of TAs per at least one of the DNN, the S-NSSAI, and the access type.

The service area restriction controller (240) is configured to receive a PDU session request message from the at last one UE (100) for the DNN and the S-NSSAI, determine whether the UE (100) is present in a TA of the list of TAs provided to the UE (100) based on the PDU session request message and perform one of accept the PDU session request when the UE (100) is present in at least one TA of the list of TAs provided to the UE (100), and reject the PDU session request when the UE (100) is not present in the at least one TA of the list of TAs provided to the UE (100).

The service area information is received from the UDM apparatus (300) by sending a request message to the UDM apparatus (300) to retrieve subscriber data in the wireless network (1000) when the registration request message is received from the at least one UE (100) and receiving the subscribed service area information along with the list of TAs per DNN and S-NSSAI from the UDM apparatus (300).

The service area restriction controller (240) is configured to detect a change in the service area information for at least one of the DNN, the S-NSSAI, and the access type for the at least one UE (100), send the change in the service area information for the DNN, the S-NSSAI, and the access type to the at least one UE (100) and enforce the service area restriction for the at least one UE (100) in the wireless network (1000) based on the changes to the service area information for at least one of the DNN, the S-NSSAI, and the access type.

A UDM apparatus (300) for enforcing service area restriction in a wireless network (1000) is provided. The UDM apparatus (300) comprises a memory (330), a processor (310) and a service area restriction controller (340), communicatively connected to the memory (330) and the processor (310), configured to receive a list of TAs along with at least one of DNN, S-NSSAI, and access type corresponding to a service area provisioned for at least one UE (100) in the wireless network (1000) from at least one of a NEF apparatus (400) and an AF apparatus (500), receive a Nudm_SDM_Get request message to retrieve subscriber data for the at least one UE (100) from an AMF apparatus (200) in the wireless network (1000) an send subscribed service area information along with the list of TAs per DNN and S-NSSAI for the at least one UE (100) to the AMF apparatus (200).

The service area restriction controller (340) is configured to receive the list of TAs corresponding to the service area information provisioned for the at least one UE (100) from the AF apparatus (500) when the AF apparatus (500) is a trusted AF apparatus.

The service area restriction controller (340) is configured to receive the list of TAs corresponding to the service area provisioned for the at least one UE (100) from the NEF apparatus (400) when the AF apparatus (500) is an untrusted AF apparatus.

The service area restriction controller (340) is configured to detect a change in the service area information for at least one of the DNN, the S-NSSAI, and the access type for the at least one UE (100) and send the updated service area information for at least one of the DNN, the S-NSSAI, and the access type for the at least one UE (100) to the AMF apparatus (200).

A NEF apparatus (400) for enforcing service area restriction in a wireless network (1000) is provided. The NEF apparatus (400) comprises a memory (430), a processor (410) and a service area restriction controller (440), communicatively connected to the memory (430) and the processor (410), configured to receive geographical location identifier (id) along with DNN and S-NSSAI provisioned for at least one UE (100) in the wireless network (1000) from an AF apparatus (500), convert geographical information to a list of TAs corresponding to service area and send the list of TAs corresponding to the service area to a UDM apparatus (300) in the wireless network (1000).

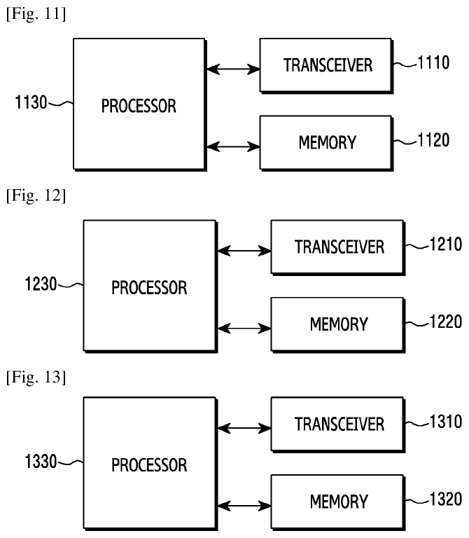

FIG. 11 illustrates a structure of a UE according to an embodiment of the disclosure.

As shown in FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 corresponds to the UE 100 of the FIG. 1.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

FIG. 12 illustrates a structure of a base station according to an embodiment of the disclosure.

As shown in FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor. Furthermore, the base station of FIG. 12 may be managed by the AMF apparatus 200 of the FIG. 1. The base station of FIG. 12 may support the communication between the UE 100 and the AMF 200.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

FIG. 13 is a block diagram showing an internal structure of a network entity, according to an embodiment of the present disclosure. As shown in FIG. 13, the network entity of the present disclosure may include a transceiver 1310, a memory 1320, and a processor 1330. The transceiver 1310, the memory 1320, and the processor (or, controller) 1330 of the network entity may operate according to a communication method of the network entity described above. However, the components of the terminal are not limited thereto. For example, the network entity may include more or fewer components than those described above. In addition, the processor 1330, the transceiver 1310, and the memory 1320 may be implemented as a single chip. Also, the processor 1330 may include at least one processor. Furthermore, the network entity of FIG. 13 corresponds to the AMF device 200 of the FIG. 1 and/or the UDM apparatus 300 of the FIG. 1.

According to the present invention, the network entity includes at least one entity of a core network. For example, the network entity includes AMF (access and mobility management function), SMF (session management function), PCF (policy control function), NRF (network repository function), UPF (user plane function), NSSF (network slicing selection function), AUSF (authentication server function), UDM (unified data management) and NEF (network exposure function). However, the network entity is not limited thereto.

The transceiver 1310 collectively refers to a network entity receiver and a network entity transmitter, and may transmit/receive a signal to/from a base station or a UE. The signal transmitted or received to or from the base station or the UE may include control information and data. In this regard, the transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the network entity. Also, the memory 1320 may store control information or data included in a signal obtained by the network entity. The memory 1320 may be a storage medium, such as ROM, RAM, a hard disk, a CD-ROM, and a DVD, or a combination of storage media.

The processor 1330 may control a series of processes such that the network entity operates as described above. For example, the transceiver 1310 may receive a data signal including a control signal, and the processor 1330 may determine a result of receiving the data signal.

1. A method performed by an access and mobility management function (AMF) entity in a mobile communication system, the method comprising:
receiving, from a user equipment (UE), a registration request message;
identifying at least one local area data network (LADN) service area per data network name (DNN) and single-network slice selection assistance information (S-NSSAI) based on information for identifying the at least one LADN service area; and
transmitting, to the UE, a registration accept message as a response to the registration request message, the registration accept message including DNN information and tracking area (TA) list information which correspond to the at least one LADN service area per DNN and S-NSSAI.

2. The method of claim 1, wherein the information is obtained from a local configuration or is received from a unified data management (UDM) entity.

3. The method of claim 1, wherein the TA list information is mapped with geographical information.

4. The method of claim 1, further comprising:
receiving, from the UE, a protocol data unit (PDU) session request message in case that the UE is in the at least one LADN service area; and
transmitting, to the UE, accept message as a response to the PDU session request message.

5. An access and mobility management function (AMF) entity in a mobile communication system, the AMF entity comprising:
a transceiver; and
a controller coupled with the transceiver and configured to:
receive, from a user equipment (UE), a registration request message;
identify at least one local area data network (LADN) service area per data network name (DNN) and single-network slice selection assistance information (S-NSSAI) based on information for identifying the at least one LADN service area; and
transmit, to the UE, a registration accept message as a response to the registration request message, the registration accept message including DNN information and tracking area (TA) list information which correspond to the at least one LADN service area per DNN and S-NSSAI.

6. The AMF entity of claim 5, wherein the information is obtained from a local configuration or is received from a unified data management (UDM) entity.

7. The AMF entity of claim 5, wherein the TA list information is mapped with geographical information.

8. The AMF entity of claim 5, wherein the controller is further configured to:
receive, from the UE, a protocol data unit (PDU) session request message in case that the UE is in the at least one LADN service area; and
transmit, to the UE, accept message as a response to the PDU session request message.

9. A method performed by a user equipment (UE) in a mobile communication system, the method comprising:
transmitting, to an access and mobility management function (AMF) entity, a registration request message; and
receiving, from the AMF entity, the registration accept message as a response to the registration request message, the registration accept message including data network name (DNN) information and tracking area (TA) list information which correspond to at least one local area data network (LADN) service area per DNN and single-network slice selection assistance information (S-NSSAI),
wherein the at least one LADN service area is based on information associated with the at least one LADN service area.

10. The method of claim 9, wherein the information associated with the at least one LADN service area is associated with a local configuration or at least one subscribed LADN service area of a unified data management (UDM) entity.

11. The method of claim 9, wherein the TA list information is mapped with geographical information.

12. The method of claim 9, further comprising:
transmitting, to the AMF entity, a protocol data unit (PDU) session request message in case that the UE is in the at least one LADN service area; and
receiving, from the AMF entity, accept message as a response to the PDU session request message.

13. A user equipment (UE) in a mobile communication system, the UE comprising:
a transceiver; and
a controller coupled with the transceiver and configured to:
transmit, to an access and mobility management function (AMF) entity, a registration request message; and
receive, from the AMF entity, the registration accept message as a response to the registration request message, the registration accept message including data network name (DNN) information and tracking area (TA) list information which correspond to at least one local area data network (LADN) service area per DNN and single-network slice selection assistance information (S-NSSAI),
wherein the at least one LADN service area is based on information associated with the at least one LADN service area.

14. The UE of claim 13, wherein the TA list information is mapped with geographical information.

15. The UE of claim 13, wherein the controller is further configured to:
transmit, to the AMF entity, a protocol data unit (PDU) session request message in case that the UE is in the at least one LADN service area; and
receive, from the AMF entity, accept message as a response to the PDU session request message.
